(19) United States
(12) Patent Application Publication
(10) Pub. No.: US 2004/0223760 A1
(43) Pub. Date: Nov. 11, 2004

(54) Optical communications access network architecture and method

(76) Inventors: Jocelyn Lauzon, Beaconsfield (CA); Sylvain Theriault, L'Ancienne-Lorette (CA); Paul Verville, Cap Rouge (CA)

Correspondence Address: OGILVY RENAULT, 1981 MCGILL COLLEGE AVENUE, SUITE 1600, MONTREAL, QC, H3A2Y3, CA

(21) Appl. No.: 10/787,928

(22) Filed: Feb. 27, 2004

Related U.S. Application Data
(60) Provisional application No. 60/450,361, filed on Feb. 28, 2003.

(51) Int. Cl. H04B 10/08

(52) U.S. Cl. 398/33

(57) ABSTRACT

A system and method for transmitting an optical signal through a downstream link of a Wavelength Division Multiplex (WDM) optical communications network, comprising a detector/filter for monitoring wavelength channels at an upstream link. An input source/filter transmits the optical signal in the wavelength channels through the downstream link. A controller receives data to be transmitted as an optical signal. The controller is connected to the detector/filter for detecting unused wavelength channels as a function of the monitoring from the detector/filter, for selecting one of the unused wavelength channels, and being connected to the input source/filter for controlling the transmission of an optical signal associated with the data on the selected wavelength channel.

### CROSS-REFERENCE TO RELATED APPLICATION

This application claims priority on U.S. Provisional Patent Application No. 60/450,361, filed on Feb. 28, 2003.

### BACKGROUND OF THE INVENTION

1. Field of the Invention

The present invention relates to optical communications and, more particularly, to an access network architecture and method for optimizing the use of optical links.

2. Background Art

In optical communications, various methods of multiplexing are used at the access network (i.e., the interface) between nodes of a lower-level and a higher-level network. For instance, a metropolitan-area network (MAN) is interfaced with a plurality of local-area networks (LAN), by multiplexing optical signals using time division multiplexing (TDM), or wavelength division multiplexing (WDM).

TDM is a method of putting multiple data streams in a single signal by separating the signal into many segments, each having a short and fixed duration (timeslot). A block of data that does not fit in a single timeslot has to be sent in two or more different non consecutive timeslots. Some timeslots (e.g., the last timeslot for a block of data) are not fully filled, thereby resulting in a reduction of the throughput efficiency of TDM system. It is also more difficult to send information in a burst mode. Traditional TDM systems also require synchronization, increasing the complexity and the cost of such systems.

WDM can be generally separated into two categories, namely, dense WDM (DWDM) and coarse WDM (CWDM). DWDM involves optical signals of low-drift wavelengths such that a plurality of optical signals can be compacted into a single connection (i.e., bandwidth of 0.8 nm). The optical signals of a CWDM are more coarsely separated (i.e., bandwidth of 20 nm).

DWDM is used normally in high-capacity long-haul systems. DWDM requires high-precision input, and has generally wavelengths dedicated to clients. Therefore, the use of a connection is not optimal if a wavelength is not fully utilized, and represents a costly solution, partly due to the relatively high costs of the high-precision input required.

Compared to long-haul networks that have a limited number of connections, a metropolitan-area network reaches a large number of clients. Cost of such a system is then very critical. CWDM uses cheaper components and it offers an advantageous balance between cost and efficiency, representing a very attractive solution for an access network.

In designing multiplexing systems and methods for optical communications, some factors are considered to obtain optimal use of networks. To reduce the cost of optical links and installation thereof, the maximization of the use of the optical links is contemplated. Due to the prohibitive cost of optical networks (components, installation), it is preferred to design multiplexing systems and methods that use the optical links to their full capacity. It is also preferred to reduce the cost of networks by reducing the required components of access network architectures.

### SUMMARY OF INVENTION

It is therefore an aim of the present invention to provide an access network architecture for optical communications which overcomes aforementioned disadvantages of the prior art.

Therefore, in accordance with the present invention, there is provided a method of transmitting an optical signal through a downstream link of a Wavelength Division Multiplex (WDM) optical communications network. According to the invention, an upstream link is monitored to detect unused wavelength channels. One of the unused wavelength channels is selected, and the optical signal transmitted through the downstream link using the selected wavelength channel.

According to the method of the present invention, nodes can be coupled to a higher-level optical communications network by determining the availability of the wavelength channels, and inputting an optical signal as a function of the availability of wavelength channels.

According to the method of the present invention, wavelength channels are not dedicated to specific nodes. Nodes use any available wavelength channel, whereby there may be more nodes than wavelength channels.

According to this method, each transmitted packet of data is encapsulated between a header and a trailer for identification and can be of any length as long as the wavelength channel remains available.

According to this method, sudden unavailability of the wavelength channel might force temporary closure of the encapsulated packet. The rest of the packet can then be transmitted on another available wavelength channel or at a later time on the same wavelength channel.

Therefore, in accordance with the present invention, there is provided a system for transmitting an optical signal through a downstream link of a Wavelength Division Multiplex (WDM) optical communications network, comprising: a detector/filter for monitoring wavelength channels at an upstream link; an input source/filter for transmitting the optical signal in any one of the wavelength channels through the downstream link; a controller for receiving data to be transmitted as an optical signal, the controller being connected to the detector/filter for detecting unused wavelength channels as a function of the monitoring from the detector/filter, for selecting one of the unused wavelength channels, and being connected to the input source/filter for controlling the transmission of an optical signal associated with said data on the selected wavelength channel.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a schematic representation of an optical communication access network using nodes in accordance with the present invention;

FIG. 2 is a schematic representation of a node of an access network architecture in accordance with a first embodiment of the present invention; and

FIG. 3 is a schematic representation of a node of an access network architecture in accordance with a second embodiment of the present invention.

### DESCRIPTION OF THE PREFERRED EMBODIMENTS

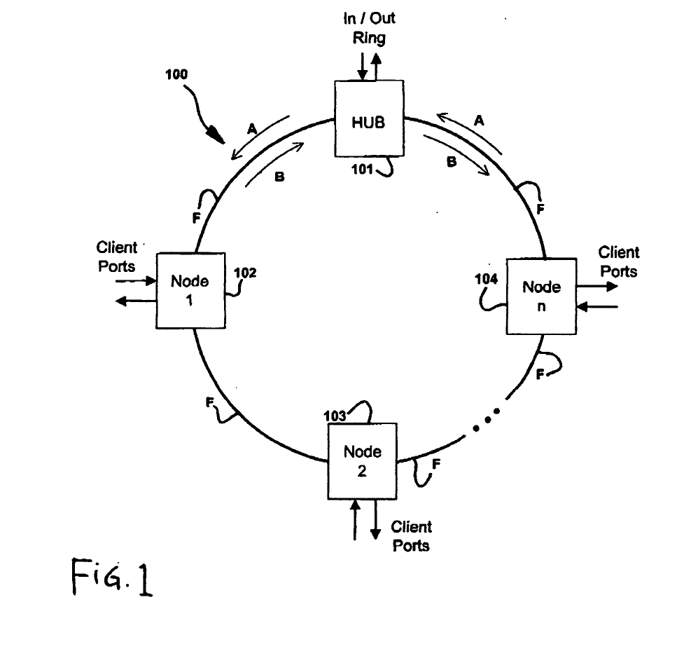

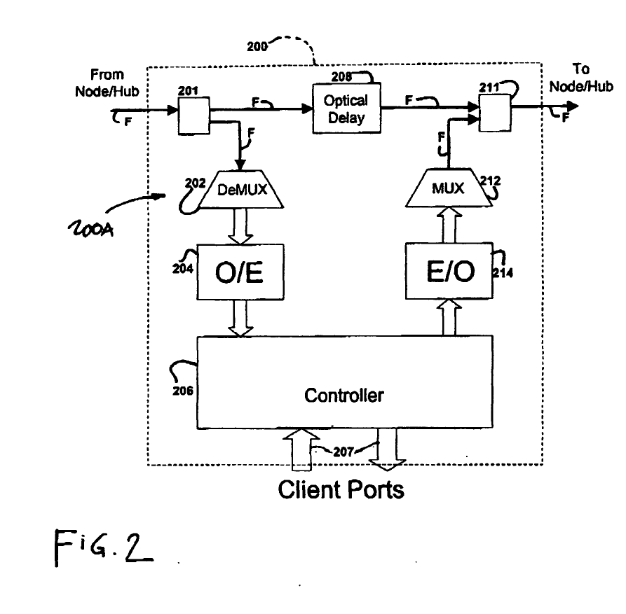

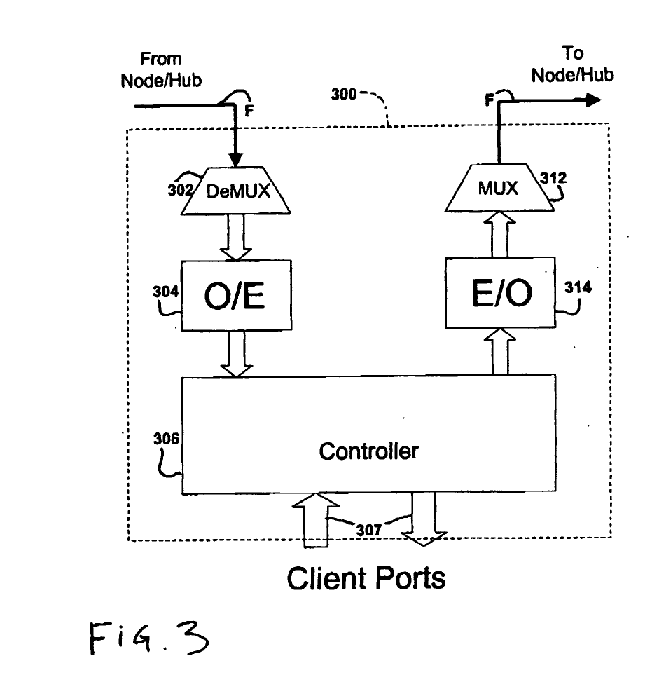

Referring to FIG. 1, an access network architecture in accordance with the present invention is generally shown on a network 100. The network 100 is a Wavelength Division Multiplex (WDM) optical communications network. A plurality of nodes 102, 103 and 104 are interfaced with an optical link F to form the network 100. The nodes 102, 103 and 104 will be described in first and second embodiments, with an all-optical (OOO) configuration node 200 in FIG. 2, and an optical-electrical-optical (OEO) configuration node 300 in FIG. 3. The network 100 has a master node called a hub 101 which is responsible for the management and operation of the network 100. Optical signals in the optical link F have a first direction illustrated by direction A, and a second direction illustrated by direction B. The optical link F can be a single optical fiber (bidirectional transmission), a group of optical fibers or a free-space optical link.

For illustrative purposes, in FIGS. 2 and 3, the optical link F will be described as an optical fiber.

Referring to FIG. 2, a node 200 that is used in the network 100 of FIG. 1 as nodes 102, 103 and 104 has at the input (i.e., upstream link) a tap coupler 201 mounted onto the optical fiber F, so as to direct portions of the optical signals toward a controller loop 200A having a demultiplexer unit 202 (hereinafter “Demux unit 202”). The tap coupler 201 includes any suitable coupler. The portions of optical signals are filtered by the Demux unit 202, prior to being fed to the photodetectors 204. The Demux unit 202 is, for instance, a fast tunable filter or a group of discrete filters.

A controller 206 is connected to the photodetectors 204 and to client ports 307, and controls input source 214. It is pointed out that source 214, and source 314, described hereinafter, are referred to as “input sources”, as they selectively serve a role of inputting client optical signals to the network, by their output. The input source 214 is, for instance, a fast tunable laser or a group of lasers emitting at different wavelengths. The optical output of the input source 214 is coupled in the optical fiber F with the multiplexer unit 212 (hereinafter “Mux unit 212”). Portions of the optical signal are inserted in the optical link F using tap coupler 211 (i.e., downstream link) or any like device appropriately coupling links to one another.

Portions of optical signals that are not directed to the Demux unit 202 bypass the controller loop 200A by passing through an optical delay 208. The optical delay 208 is typically a length of optical fiber (e.g., 20 to 30 m) or any other devices that can create an optical propagation delay (e.g., free space optical link) prior to being fed to the tap coupler 211. The output of the node comprises all the optical signals present at the input and the optical signal being transmitted by the controller 206.

Referring to FIG. 3, a node 300 that is used in the network 100 of FIG. 1 as nodes 102, 103 and 104, alternatively to the node 200 of FIG. 2, has a configuration similar to that of the node 200, but does not have an optical delay (e.g., optical delay 208 of FIG. 2) and/or tap couplers (e.g., the tap couplers 201 and 211 of FIG. 2). The node 300 sequentially has a demultiplexer unit 302 at an upstream link, photodetectors 304, a controller 306, input source 314, and a multiplexer unit 312 at a downstream link. The controller 306 is connected to client ports 307. The optical signals are fully directed toward a demultiplexer unit 302 (hereinafter “Demux unit 302”). In the present configuration, all optical signals have to be processed by a controller 306, whereby the Demux unit 302 cannot be a tunable filter in this case. Similarly, input source 314 cannot be a tunable laser because all optical signals must be reinserted in the network.

Now that a preferred configuration of components of the access network architecture of the present invention have been described, a method of transmitting an optical signal from node (i.e., nodes 200 and 300) to the optical fiber F using the access network architecture of the present invention will be described for both configurations.

Optical signals transmitted by the optical fiber F each have a different wavelength. In the node configuration of FIG. 2, portions of the signal are filtered by the Demux unit 202 and directed to wavelength-dedicated photodetectors 204. The controller 206 has then two main functions. First, it determines by analyzing the header of the optical signals if the received encapsulated packets of data for each wavelength of optical signal has to be redirected toward one of the client ports 207. The other packets are dropped by the controller 206. Second, the controller 206 determines (i.e., detects and selects) the wavelength channels availability (i.e., whether an optical signal is present in a wavelength channel) . If data has to be sent onto the network, the controller 206 will activate the input source 214 corresponding to one of the available wavelength channel to transmit a packet of data coming from one the client ports 207. The optical signal is added to the optical fiber F using the Mux unit 212 and then the tap coupler 211.

The optical delay 208 has two functions. First, it interconnects the node input to the node output (i.e., between the tap couplers 201 and 211), keeping the optical signals on the optical link F. The node 200 does not have to retransmit any of the incoming optical signals. The data is not retrieved by the node 200, only by the hub (i.e., hub 101 of FIG. 1), keeping node management to a minimum. Second, with an optical delay 208 that is long enough (e.g., with a sufficient length of fiber), it allows the controller 206 to detect the sudden unavailability of a wavelength channel that is being used by the node 200 and gives the node 200 sufficient time to stop temporarily the transmission of the encapsulated packet in the wavelength channel so as to avoid collision of data. The remainder of the packet is then transmitted on other available wavelength channels or at a later time on the same wavelength channel.

Compared to the node configuration of FIG. 3, the configuration of node 200 of FIG. 2 involves more optical components (tap couplers 201 and 211 and the optical delay 208), but node management is reduced to a minimum. There is no handshaking required with the hub to obtain permission to add packets of data onto the optical link F.

As the node configuration of FIG. 3 does not have an optical bypass, all optical signals are converted to the electrical domain by the photodetectors 304. The Demux unit 302 has to have as many filters as wavelength channels. The node 300 also has to have as many photodetectors 304 and lasers (or the like) at the input source 314 as wavelength channels. If packets of data received from the optical signals do not belong to any of the client ports 307, they are redirected by the controller 306 to the input source 314. If one or more packets of data have to be redirected to the clients ports 307, the controller 306 extracts them from the optical link F. The controller 306 can then select one of the available wavelength channels (i.e., a wavelength channel without any optical signal) or the newly released wavelength channels to insert packets of data coming from the client ports 307.

Compared to the node configuration of FIG. 2, the node configuration of FIG. 3 shows some differences that make the configuration more efficient. The data throughput is improved because the packets of data intended to the node 300 are removed from the optical link F, leaving free space for data transmission. In case of a possible data collision due to sudden wavelength unavailability, the controller 306 can delay the retransmission of a packet on a wavelength channel that is being used by the input source 314 or retransmit the packet on another available wavelength channel. In this case, with the node configuration of FIG. 3, no packet truncation is required. Each node having the node configuration of FIG. 3 has power and flexibility comparable to that of the hub 101 (FIG. 1).

The node configuration of FIG. 3 involves fewer optical components than the node configuration of FIG. 2, but requires more complex controller firmware for better wavelength channel management, resulting in a better efficiency. It is pointed out that the node configurations 200 (FIG. 2) and 300 (FIG. 3) may be used on a same network (e.g., network 100 of FIG. 1). In such a case, the node 300 will create a regeneration of the optical signals by its configuration.

The access network architecture of the priority invention is adapted to operate in both directions of the optical link F. A single optical fiber with bidirectional operation or preferably one optical fiber for each direction is used. High transmission capacities can be obtained according to the type of input source 214. As the optical fiber F can be used bi-directionally, an inherent protection can be available, whereby a same optical signal is sent in both directions to reach the destination in opposed directions. In the event that this inherent protection is not used, known protection protocols can be used as part of the optical signal.

The access network architecture of the present invention is protocol-independent, as each node adapts to the higher-level network (i.e., including the optical link F). Moreover, the access network architecture of the present invention is well suited for burst mode transmission. Generally, in WDM systems, each node has a dedicated wavelength channel or a limited timeslot on a single wavelength channel, and when the node is not using the wavelength channel, the latter cannot be used by any other node. With the access network architecture of the present invention, the number of nodes can exceed the number of wavelength channels. Therefore, although only three nodes (i.e., nodes 102, 103 and 104) are illustrated in FIG. 1, it is contemplated to provide more nodes to the network 100. The nodes are not limited to a specific wavelength channel, whereby the use of the wavelength channels is optimized.

Moreover, the time data by which the availability of the wavelength channels can be determined causes an optimal time use of the higher-level network. Unlike TDM systems, no synchronizing is required in the higher-level network, whereby time spans between periods of availability of wavelength channels are reduced. The controllers 206 and 306 are at the higher-level network, whereby no costly electronic decision devices are required at end-user nodes.

The access network architecture of the present invention is well suited for uses with coarse components/standards. For instance, the access network architecture of the present invention can be used with input sources operating under coarse WDM wavelength channels (i.e., wavelength channel bandwidths of 20 nm), yet optimize the use of the optical link F so as to optimize the use thereof and obtain output rates comparable to that of DWDM systems. It is also contemplated to use the access network architecture of the present invention with DWDM systems. Nodes may be added to existing network infrastructures with the access network architecture of the present invention.

As the users of the main network will not have a dedicated wavelength channel, a “pay-per-use” tariff structure is contemplated. Such a tariff structure would be proportional to the actual time of use of the main network.

1. A method of transmitting an optical signal through a downstream link of a Wavelength Division Multiplex (WDM) optical communications network, the method comprising steps of:
monitoring an upstream link to detect unused wavelength channels;
selecting one of the unused wavelength channels; and
transmitting the optical signal through the downstream link using the selected wavelength channel.

2. The method according to claim 1, wherein the step of monitoring the upstream link comprises steps of:
simultaneously monitoring each wavelength channel to determine whether or not a respective optical signal is present in each wavelength channel; and
for each wavelength channel, detecting that the wavelength channel is unused if it is determined that a respective optical signal is not present in the wavelength channel.

3. The method according to claim 1, further comprising a step of interrupting transmission of the optical signal if another optical signal is subsequently detected in the selected wavelength channel.

4. The method according to claim 3, further comprising the steps of selecting an other one of the unused wavelength channels and continuing transmission of the optical signal on the other one of the unused wavelength channels.

5. The method according to claim 1, further comprising the step of delaying another optical signal subsequently detected in the selected wavelength channel until the transmission of the optical signal is completed.

6. The method according to claim 1, further comprising the steps of selecting an other one of the unused wavelength channels and transferring an other optical signal subsequently detected on the selected wavelength channel on the other one of the unused wavelength channels.

7. A system for transmitting an optical signal through a downstream link of a Wavelength Division Multiplex (WDM) optical communications network, comprising:
a detector/filter for monitoring wavelength channels at an upstream link;
an input source/filter for transmitting the optical signal in any one of the wavelength channels through the downstream link;
a controller for receiving data to be transmitted as an optical signal, the controller being connected to the detector/filter for detecting unused wavelength channels as a function of the monitoring from the detector/filter, for selecting one of the unused wavelength channels, and being connected to the input source/filter for controlling the transmission of an optical signal associated with said data on the selected wavelength channel.

8. The system according to claim 7, wherein the step detector/filter simultaneously monitors each wavelength channel to determine whether or not a respective optical signal is present in each wavelength channel, and the controller, for each wavelength channel, detects that the wavelength channel is unused if it is determined that a respective optical signal is not present in the wavelength channel.

9. The system according to claim 7, further comprising:
an upstream coupler at the upstream link and connected to the detector/filter so as direct a portion of optical signal to the detector/filter;
a downstream coupler at the downstream link and connected to the input source/filter so as to transmit an optical signal transmitted by the input source/filter to any one of the wavelength channels; and
an optical delay interconnecting the upstream coupler to the downstream coupler for a remainder of the optical signals to bypass the controller;
wherein the controller controls the input source/filter to interrupt transmission of an optical signal on the selected wavelength channel if another signal is subsequently detected in the selected wavelength channel.

10. The system according to claim 9, wherein the controller selects an other one of the unused wavelength channels and controls the input source/filter to continue transmission of the optical signal on the other one of the unused wavelength channels.

11. The system according to claim 7, wherein the controller delays another optical signal subsequently detected in the selected wavelength channel until the transmission of the optical signal is completed.

12. The system according to claim 6, wherein the controller selects an other one of the unused wavelength channels and controls the input source/filter in transmitting an other optical signal subsequently detected on the selected wavelength channel on the other one of the unused wavelength channels.

13. Use of the method described in claim 1 with a pay per use tariff.
